(19) United States
(12) Patent Application Publication
(10) Pub. No.: US 2016/0168175 A1
(43) Pub. Date: Jun. 16, 2016

(54) SILYLATED POLYISOCYANATES

(71) Applicants: BASF SE, Ludwigshafen (DE); BASF COATINGS AG, Münster (DE)

(72) Inventors: Christina HAAF-KLEINHUBBERT, Hemsbach (DE); Frederic LUCAS, Offenburg (DE); Rumman AHMED, Muenster (DE); Bernd BRUCHMANN, Freinsheim (DE); Svetlana GURIYANOVA, Ludwigshafen (DE); Markus HICKL, Mannheim (DE); Horst HINTZE-BRUENING, Muenster (DE); Pieter IN 'T VELD, Ludwigshafen (DE); Dirk SCHMELTER, Muenster (DE); Verena FELDMANN, KehI (DE)

(73) Assignees: BASF SE, Ludwigshafen (DE); BASF COATINGS AG, Munster (DE)

(21) Appl. No.: 14/906,210

(22) PCT Filed: Jul. 15, 2014
(86) PCT No.: PCT/EP2014/065128

§ 371 Date: Jan. 19, 2016

(30) Foreign Application Priority Data
Jul. 19, 2013 (EP) 13177272.5

(51) Int. Cl. C07F 7/18; C08G 18/28; C08G 18/77; C09D 175/04

(52) U.S. Cl. CPC C07F 7/1836; C07F 7/1892; C07F 7/1876; C09D 175/04; C08G 18/28; C08G 18/778

(57) ABSTRACT

The present invention relates to silylated polyisocyanates, to processes for preparing them, to their use, and to coating compositions comprising them.

The present invention relates to silylated polyisocyanates, to processes for preparing them, to their use, and to coating compositions comprising them.

Pigmented paints and transparent varnishes composed or based on polyurethanes have been known for a number of decades.

More recent times have seen polyisocyanates containing isocyanate groups partly substituted by alkoxysilyl groups, giving the resulting product not only curing of the free isocyanate groups but also, with the formation of siloxane, a further curing mechanism. For a polyisocyanate architecture of this kind, it is common to use the readily commercially available 3-(trialkoxysilyl)propylamine or N-alkylated derivatives thereof—see, for example, in WO2008/074489.

A disadvantage of this reaction regime is that said reaction of isocyanate groups with 3-(trialkoxysilyl)propylamine produces urea groups, which diminish the solubility of the resultant products.

It would be desirable, for example, to attach alkoxysilyl groups via urethane groups. To do so, however, requires the use of a compound which has not only alkoxysilyl groups but also a free hydroxyl group for attachment to the isocyanate group. Such a situation is mutually exclusive, however, since the free hydroxyl group would react instantly with the alkoxysilyl group.

It was an object of the present invention to develop a process with which alkoxysilyl groups can be attached to polyisocyanates without the products exhibiting the poor solubility of polyisocyanates containing urea groups.

The object has been achieved by means of a process for preparing polyisocyanates carrying silyl groups, which comprises
in a first step reacting at least one di- or polyisocyanate (A) with at least one unsaturated alcohol (B) which carries at least one C═C double bond and at least one hydroxyl group, and
subsequently adding at least one silane compound (C) which carries at least one Si—H bond, by a hydrosilylation, to at least some of the C═C double bonds bonded thus to the resultant polyisocyanate containing urethane groups.

As a result of the specific two-step synthesis of the compounds, silylated polyisocyanates obtained in accordance with the invention do not contain the abovementioned disruptive urea groups. The polyisocyanates obtainable exhibit more ready solubility in common solvents and/or a lower melting point than the analogous polyisocyanates containing urea groups.

The di- or polyisocyanate (A) is a compound which has at least 2 free isocyanate groups. The compounds in question may be monomeric di- or polyisocyanates, or polyisocyanates obtainable by reaction of at least one diisocyanate—preferably the latter.

The diisocyanates and the monomeric isocyanates used for preparing the polyisocyanates may be aromatic, aliphatic, or cycloaliphatic diisocyanates, preferably aliphatic or cycloaliphatic, which is referred to for short in this text as (cyclo)aliphatic; aliphatic isocyanates are particularly preferred.

Aromatic isocyanates are those which comprise at least one aromatic ring system, in other words not only purely aromatic compounds but also araliphatic compounds. The aromatic isocyanates naturally display a greater reactivity, which can be boosted still further through the use of catalysts.

Cycloaliphatic isocyanates are those which comprise at least one cycloaliphatic ring system.

Aliphatic isocyanates are those which comprise exclusively linear or branched chains, i.e., acyclic compounds.

The monomeric isocyanates are preferably diisocyanates, which carry precisely two isocyanate groups.

In principle, higher isocyanates having on average more than 2 isocyanate groups are also possible. Suitability therefor is possessed for example by triisocyanates, such as tri isocyanatononane, 2′-isocyanatoethyl 2,6-diisocyanatohexanoate, 2,4,6-triisocyanatotoluene, triphenylmethane triisocyanate or 2,4,4′-triisocyanatodiphenyl ether, or the mixtures of diisocyanates, triisocyanates, and higher polyisocyanates that are obtained, for example, by phosgenation of corresponding aniline/formaldehyde condensates and represent methylene-bridged polyphenyl polyisocyanates.

These monomeric isocyanates do not contain substantially any products of reaction of the isocyanate groups with themselves.

The monomeric isocyanates are preferably isocyanates having 4 to 20 C atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate (e.g., methyl 2,6-diisocyanatohexanoate or ethyl 2,6-diisocyanatohexanoate), trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diisocyanato-1-methylcyclohexane, and also 3 (or 4), 8 (or 9)-bis(isocyanatomethyl)tricyclo[5.2.1.0^{2.6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanato-methyl)cyclohexane, isophorone diisocyanate, and 4,4′- or 2,4′-di(isocyanatocyclohexyl)methane, very particular preference to isophorone diisocyanate and hexamethylene 1,6-diisocyanate, and especial preference to hexamethylene 1,6-diisocyanate.

Mixtures of said isocyanates may also be present.

Isophorone diisocyanate is usually in the form of a mixture, specifically a mixture of the cis and trans isomers, generally in a proportion of about 60:40 to 90:10 (w/w), preferably of 70:30-90:10.

Dicyclohexylmethane 4,4′-diisocyanate may likewise be in the form of a mixture of the different cis and trans isomers.

For the present invention it is possible to use not only those diisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-isocyanato-3-isocyanatomethyl-3,5,5-trimethylcyclohexane (isophorone diisocyanate or IPDI) can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis takes place usually continuously in a circulation process and in the presence, if desired, of N-unsubstituted carbamic esters, dialkyl carbonates, and other by-products recycled from the reaction process. Diisocyanates obtained in this way generally contain a very low or even unmeasurable fraction of chlorinated compounds, which is advantageous, for example, in applications in the electronics industry.

In one embodiment of the present invention the isocyanates used have a total hydrolyzable chlorine content of less than 100 ppm, very preferably less than 30 ppm, in particular less than 20 ppm, and especially less than 10 ppm. This can be measured by means, for example, of ASTM specification D4663-98. The amounts of total chlorine are, for example, below 1000 ppm, preferably below 800 ppm, and more preferably below 500 ppm (determined by argentometric titration after hydrolysis).

It will be appreciated that it is also possible to employ mixtures of those monomeric isocyanates which have been obtained by reacting the (cyclo)aliphatic diamines with, for example, urea and alcohols and cleaving the resulting (cyclo)aliphatic biscarbamic esters, with those diisocyanates which have been obtained by phosgenating the corresponding amines.

The polyisocyanates (A) to which the monomeric isocyanates can be oligomerized are generally characterized as follows:

The average NCO functionality of such compounds is in general at least 1.8 and can be up to 8, preferably 2 to 5, and more preferably 2.4 to 4.

The isocyanate group content after oligomerization, calculated as NCO=42 g/mol, is generally from 5% to 25% by weight unless otherwise specified.

The polyisocyanates (A) are preferably compounds as follows:
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, trisisocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.
The polyisocyanates containing isocyanurate groups may also, to a minor extent, include urethane groups and/or allophanate groups, preferably with a bound alcohol content of less than 2%, based on the polyisocyanate.
2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates. The polyisocyanates containing uretdione groups are obtained in the context of this invention as a mixture with other polyisocyanates, more particularly those specified under 1). Polyisocyanates containing uretdione groups customarily have functionalities of 2 to 3.
For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 24% by weight and an average NCO functionality of 2.8 to 6.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of diisocyanate, such as of hexamethylene diisocyanate or of isophorone diisocyanate, with mono- or polyhydric alcohols, preferably alkanols. These polyisocyanates containing urethane and/or allophanate groups generally have an NCO content of 12% to 24% by weight and an average NCO functionality of 2.0 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, such as bismuth, cobalt, cesium, Zn(II) or Zr(IV) compounds, for example, in each case in the presence of monohydric, dihydric or polyhydric, preferably monohydric, alcohols.
These polyisocyanates containing urethane and/or allophanate groups frequently occur in mixed forms with the polyisocyanates specified under 1).
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.
12) The polyisocyanates 1)-11), preferably 1), 3), 4) and 6), can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups, for example, is accomplished by addition of water or by reaction with amines. The formation of urethane and/or allophanate groups is accomplished by reaction with monohydric, dihydric or polyhydric, preferably monohydric, alcohols, in the presence, if desired, of suitable catalysts. These polyisocyanates containing biuret or urethane/allophanate groups generally have an NCO content of 10% to 25% by weight and an average NCO functionality of 3 to 8.
13) Hydrophilically modified polyisocyanates, i.e., polyisocyanates which as well as the groups described under 1-12 also comprise groups which result formally from addition of molecules containing NCO-reactive groups and hydrophilizing groups to the isocyanate groups of the above molecules. The latter groups are nonionic groups such as alkylpolyethylene oxide and/or ionic groups derived from phosphoric acid, phosphonic acid, sulfuric acid or sulfonic acid, and/or their salts.
14) Modified polyisocyanates for dual cure applications, i.e., polyisocyanates which as well as the groups described under 1-13 also comprise groups resulting formally from addition of molecules containing NCO-reactive groups and UV-crosslinkable or actinic-radiation-crosslinkable groups to the isocyanate groups of the above molecules. These molecules are, for example, hydroxyalkyl (meth)acrylates and other hydroxyl-vinyl compounds.

In one preferred embodiment of the present invention the polyisocyanate (A) is selected from the group consisting of isocyanurates, biurets, urethanes, and allophanates, preferably from the group consisting of isocyanurates, urethanes, and allophanates; more preferably it is a polyisocyanate containing isocyanurate groups.

In one particularly preferred embodiment the polyisocyanate (A) encompasses polyisocyanates comprising isocyanurate groups and obtained from 1,6-hexamethylene diisocyanate.

In one further particularly preferred embodiment the polyisocyanate (A) encompasses a mixture of polyisocyanates comprising isocyanurate groups and obtained very preferably from isophorone diisocyanate and from 1,6-hexamethylene diisocyanate.

In one particularly preferred embodiment the polyisocyanate (A) is a mixture comprising low-viscosity polyisocyanates, preferably polyisocyanates comprising isocyanurate groups, with a viscosity of 200-1500 mPa*s, preferably 400-1300, low-viscosity urethanes and/or allophanates having a viscosity of 200-1600 mPa*s, more particularly 600-1500 mPa*s, and/or polyisocyanates comprising iminooxadiazinedione groups.

In this specification, unless noted otherwise, the viscosity is reported at 23° C. in accordance with DIN EN ISO 3219/A.3 in a cone/plate system with a shear rate of 1000 s⁻¹.

The silylated polyisocyanates of the invention are for example obtainable, preferably obtained, by two-step reaction of the corresponding di- or polyisocyanates. In the first step this compound is reacted with an unsaturated monoalcohol (B), preferably allyl alcohol, to whose double bond a compound (C) of the formula (V) is added in the next step by means of transition metal-catalyzed, preferably platinum-catalyzed, hydrosilylation

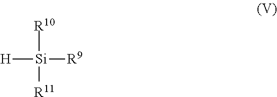

In this formula, R⁹-R¹¹ independently of one another are
an alkyl radical or
a radical —O—R¹²,
   in which

R¹² may be an alkyl or aryl radical.

Alkyl for the purposes of the present specification is straight-chain or branched alkyl groups having one to 20 carbon atoms, preferably C1-C8 alkyl groups, i.e., for example, methyl, ethyl, n-propyl, isopropyl, n-butyl, isobutyl, 2-butyl, tert-butyl, 1-pentyl, 2-pentyl, isoamyl, n-hexyl, n-octyl, or 2-ethylhexyl.

By C₁-C₄ alkyl in this specification is meant methyl, ethyl, n-propyl, isopropyl, n-butyl, isobutyl, 2-butyl, or tert-butyl.

R⁹ to R¹¹ are independently of one another alkyl, a radical of the formula —O—R¹², preferably a radical of the formula —OR¹², more preferably with R¹² as alkyl, very preferably methyl or ethyl, and more particularly ethyl.

This platinum-catalyzed hydrosilylation is frequently carried out in the following way:

The reaction product of the di- or polyisocyanate (A) used with the unsaturated monoalcohol (B) is admixed with the silicon hydride (V), in solution in an anhydrous inert solvent, at ambient temperature in a reaction vessel which is equipped with means for maintaining an inert gas blanket, preferably of nitrogen or argon, the admixing taking place with inert gas blanketing. Added with stirring is a catalyst, such as a transition metal, for example, preferably a noble metal from transition group VIII, more preferably nickel, nickel salts, iridium salts, and very preferably chloroplatinic acid or Karstedt catalyst (platinum-divinyltetramethyldisiloxane). The temperature is raised to about 60° C. under inert gas blanketing. The reaction can be monitored by NMR spectroscopy for the disappearance of the multiplet of the vinylic methine proton (—CH=5.9 ppm in CDCl3) of the allyl group.

The di- or polyisocyanate used may comprise at least one solvent which is not reactive toward isocyanate groups, examples being esters, ethers, ketones, or aromatic hydrocarbons, such as toluene or xylene-isomer mixtures, for example.

The compound (B) comprises at least one, preferably precisely one, unsaturated alcohol (B), which carries at least one, preferably precisely one, C═C double bond and at least one, preferably precisely one, hydroxyl group.

The C═C double bonds in accordance with the invention are nonactivated double bonds, which means that they are C═C double bonds or conjugated double bond systems which are not connected directly, i.e., are not directly adjacent, to any groups other than hydrogen and sp³-hybridized carbon atoms. Such sp³-hybridized carbon atoms may comprise, for example, alkyl groups, unsubstituted methylene groups, monosubstituted alkylene groups (1,1-alkylene groups) or disubstituted alkylene groups (n,n-alkylene groups).

In the case of conjugated double bond systems, the C═C double bond is conjugated with one or more further C═C double bonds and/or with an aromatic system, the bonds and/or system in question being preferably one to three, more preferably one to two, and very preferably precisely one further C═C double bond(s) and/or preferably precisely one carbocyclic aromatic ring system. Important in accordance with the invention is that in this case the conjugated double bond system is not connected directly to any groups other than hydrogen and sp³-hybridized carbon atoms. The aromatic ring system is a carbocyclic ring system; heteroaromatic systems are excluded by the invention.

The C═C double bonds are preferably isolated double bonds; alcohols (B) with conjugated double bond systems are less preferred.

Excluded, on the other hand, are those C═C double bonds which are electronically activated—that is, for example, vinyl ether groups, acrylate groups or methacrylate groups.

Located between the C═C double bonds and hydroxyl groups there is at least one sp³-hybridized carbon atom, preferably one to ten, more preferably one to five, very preferably one to three, more particularly one to two, and especially one.

Examples of compounds (B) of these kinds are allyl alcohol (2-propen-1-ol), methallyl alcohol (2-methyl-2-propen-1-ol), homoallyl alcohol (3-buten-1-ol), 1-buten-3-ol, 3-methyl-2-buten-1-ol, 2-methyl-3-buten-2-ol, 1-octen-3-ol, 2-hexen-1-ol, 1-penten-3-ol, and also, in addition, phytol, farnesol, and linalool.

Examples of compounds (B) having a plurality of C═C double bonds are 1,4-pentadien-3-ol, 1,4-hexadien-3-ol, and 5-methyl-1,4-hexadien-3-ol. Compounds having a plurality of C═C double bonds are less preferred, however.

One example of compounds (B) with C═C double bonds which are conjugated to a carbocyclic aromatic ring system is cinnamyl alcohol. Compounds with C═C double bonds conjugated to aromatics are less preferred, however.

Preference is given to allyl alcohol, methallyl alcohol, and homoallyl alcohol, particular preference to allyl alcohol.

The compound (C) is preferably a compound of the formula (V):

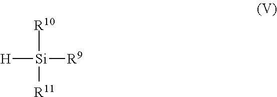

where R⁹-R¹¹ have the definition given above.

In this formula, R⁹ to R¹¹ independently of one another are preferably
a C₁-C₄ alkyl radical or
a radical —O—R¹²,
   in which

R¹² is a C₁-C₄ alkyl or phenyl radical.

More preferably R⁹ to R¹¹ are selected from the group consisting of methyl, ethyl, isopropyl, n-butyl, tert-butyl, methoxy, ethoxy, tert-butyloxy, and phenoxy, very preferably from the group consisting of methyl, ethyl, methoxy, and ethoxy.

The silanes (C) used are preferably tris(alkyloxy)silanes or alkyl bis(alkyloxy)silanes, more preferably tris(C₁-C₄-alkyloxy)silanes or C₁-C₄-alkyl-bis(C₁-C₄-alkyloxy)silanes.

The silanes (C) used are very preferably triethylsilane, triisopropylsilane, dimethylphenylsilane, diethoxymethylsilane, dimethoxymethylsilane, ethoxydimethylsilane, phenoxydimethylsilane, triethoxysilane, trimethoxysilane, bistrimethylsiloxymethylsilane, or mixtures thereof.

The stoichiometry of unsaturated alcohol (B) to the isocyanate groups in the di- or polyisocyanate (A) is generally from 1:0.1 to 0.1:1, preferably 1:0.2 to 0.2:1, more preferably 1:0.3 to 0.3:1, very preferably 1:0.5 to 0.5:1, and more particularly 1:0.66 to 0.66:1.

The stoichiometry of silane (C) according to formula (V) to double bonds in the di- or polyisocyanate, obtained by reaction with an unsaturated alcohol, is generally from 0.1:1 to 1.0:1, preferably from 0.5:1 to 1.0:1, more preferably from 0.6:1 to 1.0:1, and very preferably from 0.8:1 to 1.0:1.

Also conceivable is the use of compounds (C) which carry more than one Si—H bond, as for example at least two, preferably two to four, more preferably two or three, and very preferably two.

Examples thereof are siloxane-bridged compounds (C1) of the formula

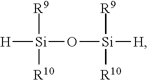

or their higher homologs with n=2 to 5

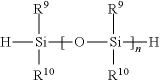

in which R⁹ and R¹⁰ may have the above definitions.

Examples of such are tetramethylsiloxane, tetraethylsiloxane, and tetraphenylsiloxane.

The reaction to the silylated polyisocyanates of the invention may take place in the first stage preferably between 40 and 120° C., more preferably between 60 and 110° C., and very preferably between 80 and 100° C., and in the second stage preferably between 40 and 80° C., more preferably between 50 and 70° C., and very preferably at 60° C.

The reaction may be carried out in bulk, but preferably in an inert, anhydrous solvent.

The reaction of the di- or polyisocyanate used with the unsaturated alcohol may take place with or without catalysis and with or without addition of an azeotrope former, such as toluene, for example. Examples of catalysts are listed below. The unsaturated alcohol is used in the ratio indicated above, according to the desired degree of substitution.

In one preferred embodiment of the present invention the ratio of alcohol (B) to di- or polyisocyanate (A) is to be selected such that the resultant polyisocyanate containing urethane groups has an average functionality of alcohol (B) of preferably at least 1, more preferably 1 to 3, very preferably 1 to 2, and especially preferably 1. If necessary, a product which carries only a few alcohol groups (B) may be reacted further by addition of further alcohol (B).

The addition of the silane (C) to the double bond of the unsaturated alcohol (B) takes place with transition metal catalysis. Transition metals contemplated are preferably those from transition group eight, more preferably platinum, rhodium, palladium, cobalt, and nickel, metallically or in the form of the complexes. One preferred catalyst is, for example, the catalyst known as Karstedt catalyst (platinum-divinyltetramethyldi-siloxane) or hexachloroplatinic acid hydrate, also for example in the form of Speier catalyst, in other words in the form of the solution in isopropanol, and also platinum on activated carbon.

The reaction in the first stage is generally carried out by introducing the unsaturated alcohol used, optionally together with the catalyst, bringing this initial charge to the desired temperature, and slowly adding the di- or polyisocyanate, optionally in solution in a suitable solvent.

The reaction with the unsaturated alcohol may take place in the absence or presence of at least one catalyst. Preferred catalysts are selected from the group consisting of compounds of tin, iron, titanium, aluminum, manganese, nickel, zinc, cobalt, zirconium, and bismuth, being preferably compounds of titanium, aluminum, zinc, zirconium, or bismuth, more preferably compounds of titanium, zinc, or bismuth, very preferably compounds of titanium or bismuth, and more particularly bismuth compounds.

Possible for example are metal complexes such as acetylacetonates of iron, of titanium, of aluminum, of zirconium, of manganese, of nickel, of zinc, and of cobalt.

Examples of compounds used as zirconium, bismuth, titanium, and aluminum compounds include the following: zirconium tetraacetylacetonate (e.g., K-KAT® 4205 from King Industries); zirconium dionates (e.g., K-KAT® XC-9213; XC-A 209 and XC-6212 from King Industries); and aluminum dionate (e.g., K-KAT® 5218 from King Industries).

Zinc compounds contemplated in this context are those in which the following anions are used: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, where n stands for the numbers 1 to 20. Preferred here are the carboxylates where the anion conforms to the formulae (CₙH₂ₙ₋₁O₂)⁻ and also (Cₙ₊₁H₂ₙ₋₂O₄)²⁻ with n being 1 to 20. Particularly preferred salts have monocarboxylate anions of the general formula (CₙH₂ₙ₋₁O₂)⁻ where n stands for the numbers 1 to 20. Especially noteworthy in this context are formate, acetate, propionate, hexanoate, neodecanoate, and 2-ethylhexanoate.

Among the zinc catalysts the zinc carboxylates are preferred, more preferably those of carboxylates having at least six carbon atoms, very preferably at least eight carbon atoms, more particularly zinc(II) diacetate, zinc(II) dioctoate, or zinc(II) neodecanoate. Examples of commercial catalysts include Borchi® Kat 22 from OMG Borchers GmbH, Langenfeld, Germany.

Among the titanium compounds the titanium tetraalcoholates Ti(OR)₄ are preferred, more preferably those of alcohols ROH having 1 to 8 carbon atoms, examples being methanol, ethanol, isopropanol, n-propanol, n-butanol, isobutanol, sec-butanol, tert-butanol, n-hexanol, n-heptanol, and n-octanol, preferably methanol, ethanol, isopropanol, n-propanol, n-butanol, or tert-butanol, more preferably isopropanol and n-butanol.

As catalyst (C), preference is given to using at least one bismuth compound, as for example one to three, preferably one or two, and more preferably precisely one compound of bismuth in the +3 oxidation state.

Bismuth compounds (C) contemplated in this context are compounds of bismuth with the following anions: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₓH₂ₓ₊₁)⁻, (CₓH₂ₓ₋₁O₂)⁻, (CₓH₂ₓ₋ₓO₂)⁻, and (Cₓ₊₁ H₂ₓ₋₂O₄)²⁻, where x stands for the numbers 1 to 20. Preferred here are the carboxylates where the anion conforms to the formulae (CₓH₂ₓ₋₁O₂)⁻ and also (Cₓ₊₁H₂ₓ₋₂O₄)²⁻ with x being 1 to 20. Particularly preferred salts have monocarboxylate anions of the general formula (CₓH₂ₓ₋₁O₂)⁻ where x stands for the numbers 1 to 20, preferably 1 to 10. Especially noteworthy in this context are formate, acetate, propionate, hexanoate, neodecanoate, and 2-ethylhexanoate.

Preferred among the bismuth catalysts are the bismuth carboxylates, more preferably those of carboxylates which have at least six carbon atoms, more particularly bismuth octoates, ethylhexanoates, neodecanoates, or pivalates; examples are K-KAT 348, XC-B221; XC-C227, XC 8203, and XK-601 from King Industries, TIB KAT 716, 716LA, 716XLA, 718, 720, and 789 from TIB Chemicals, and those from Shepherd Lausanne, and also, for example, Borchi® Kat 24, 315, and 320 from OMG Borchers GmbH, Langenfeld, Germany.

Mixtures of different metals may also be relevant in this context, such as, for example, in Borchi® Kat 0245 from OMG Borchers GmbH, Langenfeld, Germany.

Particularly preferred, however, are bismuth neodecanoate, bismuth 2-ethylhexanoate, and zinc 2-ethyl hexanoate.

It is possible to boost the effect of the catalysts additionally through the presence of acids, as for example through acids having a pKa of <2.5, as described in EP 2316867 A1, or with a pKa of between 2.8 and 4.5, as described in WO 04/029121 A1. Preferred is the use of acids with a pKa of not more than 4.8, more preferably of not more than 2.5.

The reaction product obtained can be purified by column chromatography on silica gel (Silicagel Si 60, 40-63 μm, Merck) with an eluent mixture of ethyl acetate and pentane in a ratio of 1:2. In general, however, the level of impurities in the crude product is minimal, and it can be used in the subsequent synthesis without further purification.

The second reaction stage is generally carried out by introducing the preliminary product from the first reaction stage, preferably under an inert atmosphere, together with the corresponding silane, in an anhydrous, inert solvent, and adding—with vigorous stirring—a solution of the transition metal catalyst in the same solvent. The reaction mixture is stirred at the abovementioned temperature for 30 minutes to 24 hours, preferably 1 to 20 hours, and subsequently, optionally, is freed from solvent under reduced pressure. There is no need for the product to be worked up and so preferably it is not.

The silylated polyisocyanate obtained has a viscosity at 23° C. in accordance with ISO 3219/B of preferably between 100 and 20 000 mPas, more preferably between 500 and 10 000 mPas.

The shear rate in this case ought preferably to be 250 s⁻¹.

The number-average molar weight Mₙ of the silylated polyisocyanates obtained, is generally less than 3500 g/mol, preferably less than 3000 g/mol, and more preferably less than 2500 (as determined by gel permeation chromatography using tetrahydrofuran and polystyrene as standard, DIN 55672, part 1).

The silylated polyisocyanate obtained in accordance with the invention may subsequently be mixed with commonplace solvents.

Examples of such solvents are aromatic and/or (cyclo)aliphatic hydrocarbons and mixtures thereof, halogenated hydrocarbons, esters, ethers, and alcohols.

Preference is given to aromatic hydrocarbons, (cyclo)aliphatic hydrocarbons, alkanoic acid alkyl esters, alkoxylated alkanoic acid alkyl esters, and mixtures thereof.

Particular preference is given to mono- or polyalkylated benzenes and naphthalenes, alkanoic acid alkyl esters and alkoxylated alkanoic acid alkyl esters, and mixtures thereof.

Preferred aromatic hydrocarbon mixtures are those which comprise predominantly aromatic C₇ to C₁₄ hydrocarbons and which span a boiling range from 110 to 300° C.; particular preference is given to toluene, o-, m- or p-xylene, trimethylbenzene isomers, tetramethylbenzene isomers, ethylbenzene, cumene, tetrahydronaphthalene, and mixtures comprising them.

Examples thereof are the Solvesso® grades from ExxonMobil Chemical, especially Solvesso® 100 (CAS No. 64742-95-6, predominantly C₉ and C₁₀ aromatics, boiling range about 154 to 178° C.), 150 (boiling range about 182 to 207° C.), and 200 (CAS No. 64742-94-5), and also the Shellsol® grades from Shell. Hydrocarbon mixtures of paraffins, cycloparaffins, and aromatics are also available commercially under the Kristalloel names (for example, Kristalloel 30, boiling range about 158 to 198° C. or Kristalloel 60: CAS No. 64742-82-1), white spirit (for example likewise CAS No. 64742-82-1) or solvent naphtha (light: boiling range about 155 to 180° C., heavy: boiling range about 225 to 300° C.). The aromatics content of hydrocarbon mixtures of this type is generally more than 90%, preferably more than 95%, more preferably more than 98%, and very preferably more than 99%, by weight. It may be sensible to use hydrocarbon mixtures having a particularly reduced naphthalene content.

The density at 20° C. to DIN 51757 of the hydrocarbons can be less than 1 g/cm³, preferably less than 0.95 and more preferably less than 0.9 g/cm³.

The aliphatic hydrocarbons content is generally less than 5%, preferably less than 2.5%, and more preferably less than 1%, by weight.

Halogenated hydrocarbons are for example chlorobenzene and dichlorobenzene or its isomer mixtures.

Esters are for example n-butyl acetate, ethyl acetate, 1-methoxyprop-2-yl acetate, and 2-methoxyethyl acetate, and also the monoacetyl and diacetyl esters of ethylene glycol, diethylene glycol, triethylene glycol, propylene glycol, dipropylene glycol or tripropylene glycol, such as, for example, butylglycol acetate. Further examples are also carbonates, such as preferably 1,2-ethylene carbonate, 1,2-propylene carbonate or 1,3-propylene carbonate.

Ethers are for example tetrahydrofuran (THF), dioxane, and also the dimethyl, diethyl or di-n-butyl ethers of ethylene glycol, diethylene glycol, triethylene glycol, propylene glycol, dipropylene glycol or tripropylene glycol.

(Cyclo)aliphatic hydrocarbons are for example decalin, alkylated decalin, and isomer mixtures of linear or branched alkanes and/or cycloalkanes.

Of further preference are n-butyl acetate, ethyl acetate, 1-methoxyprop-2-yl acetate, 2-methoxyethyl acetate, and also mixtures thereof, especially with the aromatic hydrocarbon mixtures set out above.

Mixtures of this kind may be produced in a volume ratio of 10:1 to 1:10, preferably in a volume ratio of 5:1 to 1:5, and more preferably in a volume ratio of 1:1.

Preferred examples are butyl acetate/xylene, 1:1 methoxypropyl acetate/xylene, 1:1 butyl acetate/solvent naphtha 100, 1:2 butyl acetate/Solvesso® 100, and 3:1 Kristalloel 30/Shellsol® A.

Alcohols are for example methanol, ethanol, n-propanol, isopropanol, n-butanol, sec-butanol, isobutanol, pentanol isomer mixtures, hexanol isomer mixtures, 2-ethylhexanol or octanol.

It is an advantage of the silylated polyisocyanates of the invention that, in coating materials, they exhibit hardness and gloss properties that are comparable with or even an improvement on those of the unsilylated polyisocyanates. In addition, they have a further crosslinking mechanism, via the silyl groups that are present.

Curing is generally accomplished by drying the coatings—following application of the coating of the substrates with the coating compositions or formulations comprising the polyisocyanates of the invention, optionally admixed with further, typical coatings additives and thermally curable resins—if desired at a temperature below 80° C., preferably room temperature to 60° C., and more preferably room temperature to 40° C., for a time of up to 72 hours, preferably up to 48 hours, more preferably up to 24 hours, very preferably up to 12 hours, and in particular up to 6 hours, and subjecting them to thermal treatment (curing) under an oxygen-containing atmosphere, preferably air, or under inert gas at temperatures between 80 and 270° C., preferably between 100 and 240° C., and more preferably between 120 and 180° C. Curing of the coating takes place, as a function of the amount of coating material applied and of the crosslinking energy introduced, via high-energy radiation, heat transfer from heated surfaces, or via convection of gaseous media, over a period of from seconds, for example, in the case of coil coating in combination with NIR drying, up to 5 hours, for example, high-build systems on temperature-sensitive materials, usually not less than 10 minutes, preferably not less than 15 minutes, more preferably not less than 30 minutes, and very preferably not less than 45 minutes. Drying essentially comprises removal of existing solvent, and in addition there may also even at this stage be reaction with the binder, whereas curing essentially comprises reaction with the binder.

Instead of or in addition to thermal curing, curing may also take place by means of IR and NIR radiation, with NIR radiation here denoting electromagnetic radiation in the wavelength range from 760 nm to 2.5 μm, preferably from 900 to 1500 nm.

Curing takes place in a time of 1 second to 60 minutes, preferably of 1 minute to 45 minutes.

The present invention further provides coating compositions comprising at least one silylated polyisocyanate of the invention.

As binders, coating compositions of this kind comprise at least one binder comprising groups that are reactive toward isocyanate. These are, generally, selected from the group consisting of hydroxyl-containing binders and amino-containing binders.

The hydroxyl-containing binder preferably comprises polyetherols, polyesterols, polyacrylate polyols, polycarbonate polyols, alkyd resins or epoxy resins. Polyesterols and polyacrylate polyols are particularly preferred, very particular preference being given to polyacrylate polyols.

The binders have on average per molecule at least two, preferably two to ten, more preferably three to ten, and very preferably three to eight hydroxyl groups.

The OH number, measured to DIN 53240-2, is generally from 10 to 200 mg KOH/g, preferably from 30 to 140.

The binders may additionally have an acid number to DIN EN ISO 3682 of 0 to 200 mg KOH/g, preferably 0 to 100, and more preferably 0 to 10 mg KOH/g.

The polyacrylate polyols are, for example, those which are copolymers of (meth)acrylic esters with at least one compound having at least one, preferably precisely one, hydroxyl group and at least one, preferably precisely one, (meth)acrylate group.

The latter may be, for example, monoesters of α,β-unsaturated carboxylic acids, such as acrylic acid, methacrylic acid (referred to in this text for short as “(meth)acrylic acid”), with diols or polyols which have preferably 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, neopentyl glycol hydroxypivalate, 2-ethyl-1,3-propanediol, 2-methyl-1,3-propanediol, 2-butyl-2-ethyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3-, and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, poly-THF having a molar weight between 162 and 2000, poly-1,3-propanediol or polypropylene glycol having a molar weight between 134 and 2000, or polyethylene glycol having a molar weight between 238 and 2000.

Preference is given to 2-hydroxyethyl acrylate, 2-hydroxyethyl methacrylate, 2- or 3-hydroxypropyl acrylate, 1,4-butanediol monoacrylate or 3-(acryloyloxy)-2-hydroxypropyl acrylate, and particular preference to 2-hydroxyethyl acrylate and/or 2-hydroxyethyl methacrylate.

The hydroxyl-bearing monomers are employed in the copolymerization in mixture with other polymerizable, preferably free-radically polymerizable, monomers, preferably those composed of more than 50% by weight of C₁-C₂₀ alkyl (meth)acrylate, vinylaromatics having up to 20 carbon atoms, vinyl esters of carboxylic acids comprising up to 20 carbon atoms, vinyl halides, nonaromatic hydrocarbons having 4 to 8 carbon atoms and 1 or 2 double bonds, unsaturated nitriles, and mixtures thereof. Particular preference is given to the polymers composed of more than 60% by weight of C₁-C₁₀ alkyl (meth)acrylates, styrene or mixtures thereof.

The polymers may further comprise hydroxyl-functional monomers in keeping with the above hydroxyl group content, and, if desired, further monomers, examples being ethylenically unsaturated acids, especially carboxylic acids, acid anhydrides or acid amides.

Further binders are polyesterols, such as are obtainable by condensing polycarboxylic acids, especially dicarboxylic acids, with polyols, especially diols.

Polyester polyols are known for example from Ullmanns Encyklopädie der technischen Chemie, 4th edition, volume 19, pp. 62 to 65. It is preferred to use polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may be optionally substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, isomers thereof, hydrogenation products thereof, and esterifiable derivatives thereof, such as anhydrides or dialkyl esters, such as C₁-C₄ alkyl esters, preferably methyl, ethyl or n-butyl esters, of the stated acids. Preference is given to dicarboxylic acids of the general formula HOOC—(CH₂)_{y}—COOH, in which y is a number from 1 to 20, preferably an even number from 2 to 20; particular preference is given to succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass between 162 and 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which optionally may be alkoxylated as described above.

Preference is given to alcohols of the general formula HO—(CH₂)ₓ—OH, in which x is a number from 1 to 20, preferably an even number from 2 to 20. Preference is given to ethylene glycol, butane-1,4-diol, hexane-1,6-diol, octane-1,8-diol and dodecane-1,12-diol. Preference is further given to neopentyl glycol.

Also suitable are polycarbonate diols, such as may be obtained, for example, by reacting phosgene with an excess of the low molecular mass alcohols as specified as synthesis components for the polyester polyols.

Also suitable are lactone-based polyester diols, which are homopolymers or copolymers of lactones, preferably hydroxy-terminal addition products of lactones with suitable difunctional starter molecules. Suitable lactones are preferably those derived from compounds of the general formula HO—(CH₂)_{z}—COOH, in which z is a number from 1 to 20 and one hydrogen atom of a methylene unit may also be substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Suitable starter components are, for example, the low molecular mass dihydric alcohols specified above as a synthesis component for the polyester polyols. The corresponding polymers of e-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxycarboxylic acids corresponding to the lactones.

Further suitable polymers are polyetherols, which are prepared by addition reaction of ethylene oxide, propylene oxide or butylene oxide with H-active components. Polycondensates of butanediol are suitable as well.

The polymers can of course also be compounds having primary or secondary amino groups.

Suitability is further possessed by polycarbonate polyols, such as may be obtained, for example, by reacting phosgene with an excess of the low molecular mass alcohols specified as synthesis components for the polyester polyols.

Alkyd resins are polycondensation resins made from polyols, polybasic carboxylic acids, and fatty oils, or free natural and/or synthetic fatty acids; at least one polyol must have a functionality of three or more.

As polyols and polybasic carboxylic acids it is possible for example to employ the components specified above in connection with the polyesterols.

Preferred polyhydric alcohols are glycerol, pentaerythritol, trimethylolethane, trimethylolpropane, various diols such as ethane-/propanediol, diethylene glycol, neopentyl glycol.

Preferred polybasic carboxylic acids are phthalic acid (anhydride) (PAA), isophthalic acid, terephthalic acid, trimellitic anhydride, adipic acid, azelaic acid, sebacic acid.

Examples of suitable oil components and/or fatty acids include drying oils, such as linseed oil, oiticica oil or tung oil, semidrying oils, such as soybean oil, sunflower oil, safflower oil, ricinene oil or tall oil, nondrying oils, such as castor oil, coconut oil or peanut oil, or free fatty acids of above oils, or synthetic monocarboxylic acids.

The molar mass of typical alkyd resins is between 1500 and 20 000, preferably between 3500 and 6000. The acid number is preferably 2 to 30 mg KOH/g, or 35 to 65 mg KOH/g in the case of water-thinnable resins. The OH number is generally up to 300, preferably up to 100 mg KOH/g.

Polyacrylate polyols, polyesterols and/or polyetherols of this kind have a molecular weight Mₙ of preferably at least 1000, more preferably at least 2000, and very preferably at least 5000 g/mol. The molecular weight Mₙ can be for example up to 200 000, preferably up to 100 000, more preferably up to 80 000, and very preferably up to 50 000 g/mol.

Furthermore, the polyisocyanates of the invention may also be used together with noncrosslinkable binders, i.e., those without groups that are reactive toward isocyanate. In this case the polyisocyanates of the invention crosslink by condensation of their silane groups with one another.

The crosslinking is accelerated generally by addition of acids.

Weak acids for the purposes of this text are monobasic or polybasic, organic or inorganic, preferably organic, acids having a pKₐ of between 1.6 and 5.2, preferably between 1.6 and 3.8.

Examples thereof are carbonic acid, phosphoric acid, formic acid, acetic acid, and maleic acid, glyoxylic acid, bromoacetic acid, chloroacetic acid, thioglycolic acid, glycine, cyanoacetic acid, acrylic acid, malonic acid, hydroxypropanedioic acid, propionic acid, lactic acid, 3-hydroxypropionic acid, glyceric acid, alanine, sarcosine, fumaric acid, acetoacetic acid, succinic acid, isobutyric acid, pentanoic acid, ascorbic acid, citric acid, nitrilotriacetic acid, cyclopentanecarboxylic acid, 3-methylglutaric acid, adipic acid, hexanoic acid, benzoic acid, cyclohexanecarboxylic acid, heptanedioic acid, heptanoic acid, phthalic acid, isophthalic acid, terephthalic acid, tolylic acid, phenylacetic acid, phenoxyacetic acid, mandelic acid or sebacic acid.

Preference is given to organic acids, preferably monobasic or polybasic carboxylic acids. Particular preference is given to formic acid, acetic acid, maleic acid or fumaric acid.

Strong acids for the purposes of this text are monobasic or polybasic, organic or inorganic, preferably organic acids having a pKₐ of less than 1.6 and more preferably less than 1.

Examples thereof are sulfuric acid, pyrophosphoric acid, sulfurous acid, and tetrafluoroboric acid, trichloroacetic acid, dichloroacetic acid, oxalic acid, and nitroacetic acid. Preference is given to organic acids, preferably organic sulfonic acids. Particular preference is given to methanesulfonic acid, para-toluenesulfonic acid, benzenesulfonic acid, dodecylbenzenesulfonic acid, cyclododecanesulfonic acid, and camphorsulfonic acid.

The acids are used in amounts in general of up to 10% by weight, preferably 0.1% to 8%, more preferably 0.3% to 6%, very preferably 0.5% to 5%, and in particular from 1% to 3% by weight, based on the polyurethane employed.

The acids may also be used as free acids or in blocked form.

Examples of further, typical coatings additives used can be antioxidants, stabilizers, activators (accelerants), fillers, pigments, dyes, antistatic agents, flame retardants, thickeners, thixotropic agents, surface-active agents, viscosity modifiers, plasticizers or chelating agents.

Suitable thickeners, in addition to free-radically (co)polymerized (co)polymers, include customary organic and inorganic thickeners such as hydroxymethylcellulose or bentonite.

Chelating agents which can be used include, for example, ethylenediamineacetic acid and its salts, and also β-diketones.

Suitable fillers comprise silicates, examples being silicates obtainable by silicon tetrachloride hydrolysis, such as Aerosil® from Evonik, siliceous earth, talc, aluminum silicates, magnesium silicates, calcium carbonates, etc.

Suitable stabilizers comprise typical UV absorbers such as oxanilides, triazines, and benzotriazole (the latter available as Tinuvin® grades from BASF SE, Ludwigshafen), and benzophenones. They can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacinate. Stabilizers are used usually in amounts of 0.1% to 5.0% by weight, based on the solid components comprised in the preparation.

Pigments may likewise be comprised. Pigments, according to CD Römpp Chemie Lexikon—Version 1.0, Stuttgart/New York: Georg Thieme Verlag 1995, with reference to DIN 55943, are particulate, “organic or inorganic, chromatic or achromatic colorants which are virtually insoluble in the application medium”.

Virtually insoluble here means a solubility at 25° C. of below 1 g/1000 g of application medium, preferably below 0.5 g, more preferably below 0.25 g, very preferably below 0.1 g, and in particular below 0.05 g/1000 g of application medium.

Examples of pigments comprise any desired systems of absorption pigments and/or effect pigments, preferably absorption pigments. There are no restrictions whatsoever governing the number and selection of the pigment components. They can be adapted as desired to the particular requirements, such as the desired color impression, for example.

By effect pigments are meant all pigments which exhibit a platelet-shaped construction and impart specific decorative color effects to a surface coating. The effect pigments comprise, for example, all of the effect-imparting pigments which can be employed commonly in vehicle finishing and industrial coating. Examples of effect pigments of this kind are pure metal pigments, such as aluminum, iron or copper pigments; interference pigments, such as titanium-dioxide-coated mica, iron-oxide-coated mica, mixed-oxide-coated mica (e.g., with titanium dioxide and Fe₂O₃ or titanium dioxide and Cr₂O₃), metal-oxide-coated aluminum, or liquid-crystal pigments.

The color-imparting absorption pigments are, for example, customary organic or inorganic absorption pigments which can be used in the coatings industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

The coating compositions of the invention, accordingly, are constituted as follows:
at least one silylated polyisocyanate of the invention,
optionally at least one catalyst capable of catalyzing the reaction of isocyanate groups with isocyanate-reactive groups,
at least one binder having isocyanate-reactive groups,
optionally at least one typical coatings additive,
optionally at least one solvent, and
optionally at least one pigment.

The substrates are coated with the coating compositions of the invention in accordance with conventional techniques which are known to the skilled person, and which involve applying at least one coating composition or formulation of the invention to the target substrate in the desired thickness, and removing the volatile constituents of the coating composition, with heating if desired (drying). This operation may if desired be repeated one or more times. Application to the substrate may be made in a known way, as for example by spraying, troweling, knife coating, brushing, rolling, roller-coating or pouring. The coating thickness is generally in a range from about 3 to 1000 g/m² and preferably 10 to 200 g/m².

Curing may then be carried out as described above.

Examples of suitable substrates for the coating compositions of the invention include thermoplastic polymers, particularly polymethyl methacrylates, polybutyl methacrylates, polyethylene terephthalates, polybutylene terephthalates, polyvinylidene fluorides, polyvinyl chlorides, polyesters, polyolefins, acrylonitrile-ethylene-propylene-diene-styrene copolymers (A-EPDM), polyether imides, polyether ketones, polyphenylene sulfides, polyphenylene ethers or mixtures thereof.

Mention may further be made of polyethylene, polypropylene, polystyrene, polybutadiene, polyesters, polyamides, polyethers, polycarbonate, polyvinylacetal, polyacrylonitrile, polyacetal, polyvinyl alcohol, polyvinyl acetate, phenolic resins, urea resins, melamine resins, alkyd resins, epoxy resins or polyurethanes, block or graft copolymers thereof, and blends of these.

Mention may preferably be made of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, PIB, PMMA, POM, PP, PPS, PS, PSU, PUR, PVAC, PVAL, PVC, PVDC, PVP, SAN, SB, SMS, UF, UP plastics (abbreviated names in accordance with DIN 7728), and aliphatic polyketones.

Particularly preferred substrates are polyolefins, such as PP (polypropylene), which optionally may be isotactic, syndiotactic or atactic and optionally may be unoriented or may have been oriented by uniaxial or biaxial stretching, SAN (styrene-acrylonitrile copolymers), PC (polycarbonates), PVC (polyvinyl chlorides), PMMA (polymethyl methacrylates), PBT (poly(butylene terephthalate)s), PA (polyamides), ASA (acrylonitrile-styrene-acrylate copolymers) and ABS (acrylonitrile-butadiene-styrene copolymers), and also their physical mixtures (blends). Particular preference is given to PP, SAN, ABS, ASA and also blends of ABS or ASA with PA or PBT or PC. Very particular preference is given to polyolefins, PMMA, and PVC.

ASA is especially preferred, particularly in accordance with DE 196 51 350, and the ASA/PC blend. Preference is likewise given to polymethyl methacrylate (PMMA) or impact-modified PMMA.

A further-preferred substrate for coating with the coating compositions of the invention are metals, which, if desired, may have been pretreated with a primer.

As far as the type of metal is concerned, suitable metals may in principle be any desired metals. In particular, however, they are metals or alloys of the kind customarily employed as metallic materials of construction, requiring protection against corrosion.

The surfaces in question are in particular those of iron, steel, Zn, Zn alloys, Al or Al alloys. These are the surfaces of elements composed entirely of the metals or alloys in question. Alternatively, the elements may have been only coated with these metals and may themselves be composed of materials of other kinds, such as other metals, alloys, polymers or composite materials. They may be the surfaces of castings made from galvanized iron or steel. In one preferred embodiment of the present invention the surfaces are steel surfaces.

Zn alloys or Al alloys are known to the skilled person. The skilled person selects the nature and amount of alloying constituents in accordance with the desired end-use application. Typical constituents of zinc alloys comprise, in particular, Al, Pb, Si, Mg, Sn, Cu or Cd. Typical constituents of aluminum alloys comprise, in particular, Mg, Mn, Si, Zn, Cr, Zr, Cu or Ti. The alloys may also be Al/Zn alloys in which Al and Zn are present in an approximately equal amount. Steel coated with alloys of these kinds is available commercially. The steel may comprise the customary alloying components known to the skilled person.

Also conceivable is the use of the coating compositions of the invention for treating tin-plated iron/steel (tinplate).

The coating compositions and formulations of the invention are additionally suitable for coating substrates such as wood, paper, textile, leather, nonwoven, plastics surfaces, glass, ceramic, mineral building materials, such as cement moldings and fiber-cement slabs, or coated or uncoated metals, preferably plastics or metals, particularly in the form of sheets, more preferably metals.

The polyisocyanates, coating compositions or coating formulations of the invention are suitable as or in exterior coatings, i.e., applications where they are exposed to daylight, preferably parts of buildings, interior coatings, and coatings on vehicles and aircraft. In particular the polyisocyanates and coating compositions of the invention are used as or in automotive clearcoat and topcoat material(s). Further preferred applications are in can coating and coil coating.

They are particularly suitable for use as primers, surfacers, pigmented topcoat materials, and clearcoat materials in the segments of industrial, wood, automotive, especially OEM, coating, or decorative coating. The coating compositions are especially suitable for applications where there is a need for particularly high application reliability, external weathering resistance, optical qualities, solvent resistance and/or chemical resistance.

The examples which follow are intended to illustrate the properties of the invention but without restricting it.

### EXAMPLES

Parts in this text, unless indicated otherwise, are by weight.

Basonat® HI 100: HDI isocyanurate available commercially from BASF SE, Ludwigshafen, Germany, and having an NCO content of 22.2% and a viscosity of 2800 mPa*s at 23° C.

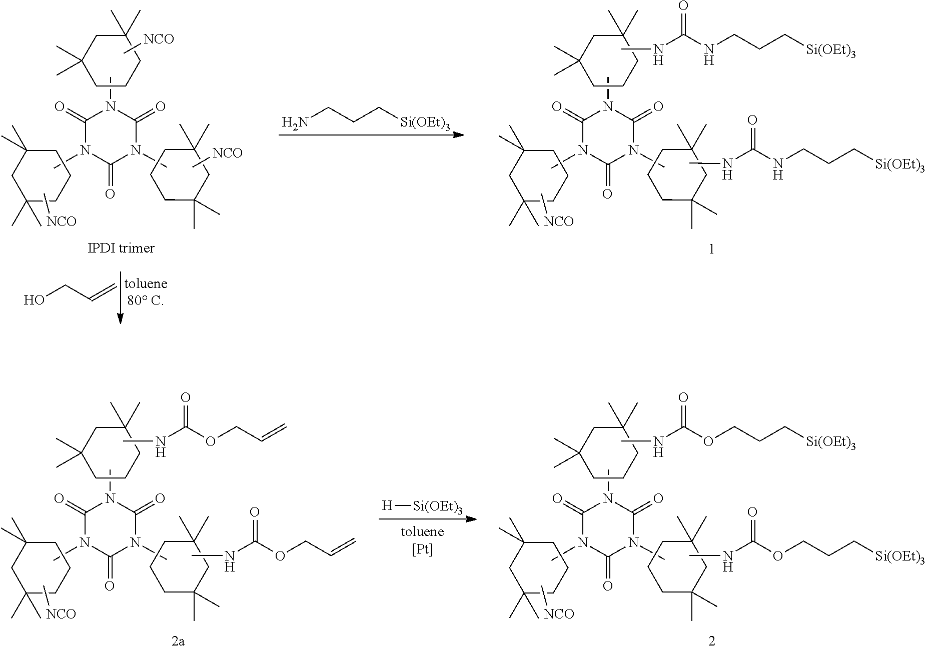

### Inventive Example 1

5 g of Vestanat® T 1890 E (commercially available polyisocyanate containing isocyanurate groups and based on isophorone diisocyanate, from Evonik) was freed from the solvent under reduced pressure. The colorless solid that remained was reacted with 3 ml of allyl alcohol from Aldrich for 48 hours, in 25 ml of toluene and at 80° C., to give a product 2a having on average 2 allyl groups. This product was dissolved in 5 ml of absolute toluene. The solution was heated to 65° C. and 2.64 ml of HSi(OEt)3 from ABCR were added. With vigorous stirring, 100 μl of a solution of Pt-divinyltetramethyldisiloxane (2.1% Pt) in xylene from ABCR Gelest were added. After 2 hours the solvent was distilled off under reduced pressure at 50° C. This gave 6.1 g of a colorless resin 2.

### Comparative Example 1

5 g of Vestanat® T 1890 E from Evonik were reacted with 2.2 ml of 3-(triethoxysilyl)-propylamine from Aldrich in 25 ml of dry dichloromethane for 30 minutes at room temperature to give a product 1 having on average 2 urea groups, in the form of a colorless solid.

The melting points were determined as being as follows:

Compound 1 from comparative example 1: about 110-120° C.

Compound 2 from inventive example 1: about 65-70° C.

Also determined was the solubility in n-butyl acetate.

0.5 g of compound 1 from comparative example 1 was admixed with 0.2 ml of butyl acetate. A glasslike solid was obtained.

0.5 g of compound 2 from inventive example 1 was admixed with 0.2 ml of butyl acetate. A high-viscosity solution was obtained.

It is seen that as a result of the inventive modification, the compound 2 from inventive example 1, with urethane groups, has a lower melting point and a higher solubility than the analogous compound 1 from comparative example 1, with urea groups.

### Inventive Example 2

10 g of Basonat® HI 100 from BASF SE were reacted with 1.2 ml of allyl alcohol from Aldrich in 50 ml of toluene for 24 hours at 80° C. to give an intermediate having on average 1 allyl group. 2 g of this intermediate were dissolved in 5 ml of absolute THF. The solution was heated to 65° C. and 0.65 ml of HSi(OEt)3 from ABCR was added. With vigorous stirring, 50 μl of a solution of Pt-divinyltetramethyldisiloxane (2.1% Pt) in xylene from ABCR Gelest were added. After 6 hours the solvents were distilled off under reduced pressure at 50° C. This gave 2.5 g of a colorless oil.

Measurements were made of the surface tension of the intermediate and of the end product:

Intermediate: 45.96±2.44 mN/m

End product: 29.49±0.95 mN/m

It is seen that the surface tension is lowered through attachment of the alkoxy-silanes.

### Comparative Example 2

5 g of Basonat HI 100 from BASF SE were reacted with 2.3 ml of 3-(triethoxysilyl)-propylamine from Aldrich in 50 ml of dry dichloromethane at room temperature for 30 minutes, to give a product having on average 1 urea group, in the form of a colorless solid.

It is seen that this product bearing urea groups from comparative example 2 is a solid, whereas the end product from inventive example 2, with urethane groups, represents a colorless oil.

The products were characterized by 1H-NMR and IR spectroscopy.

### Inventive Examples 3-4

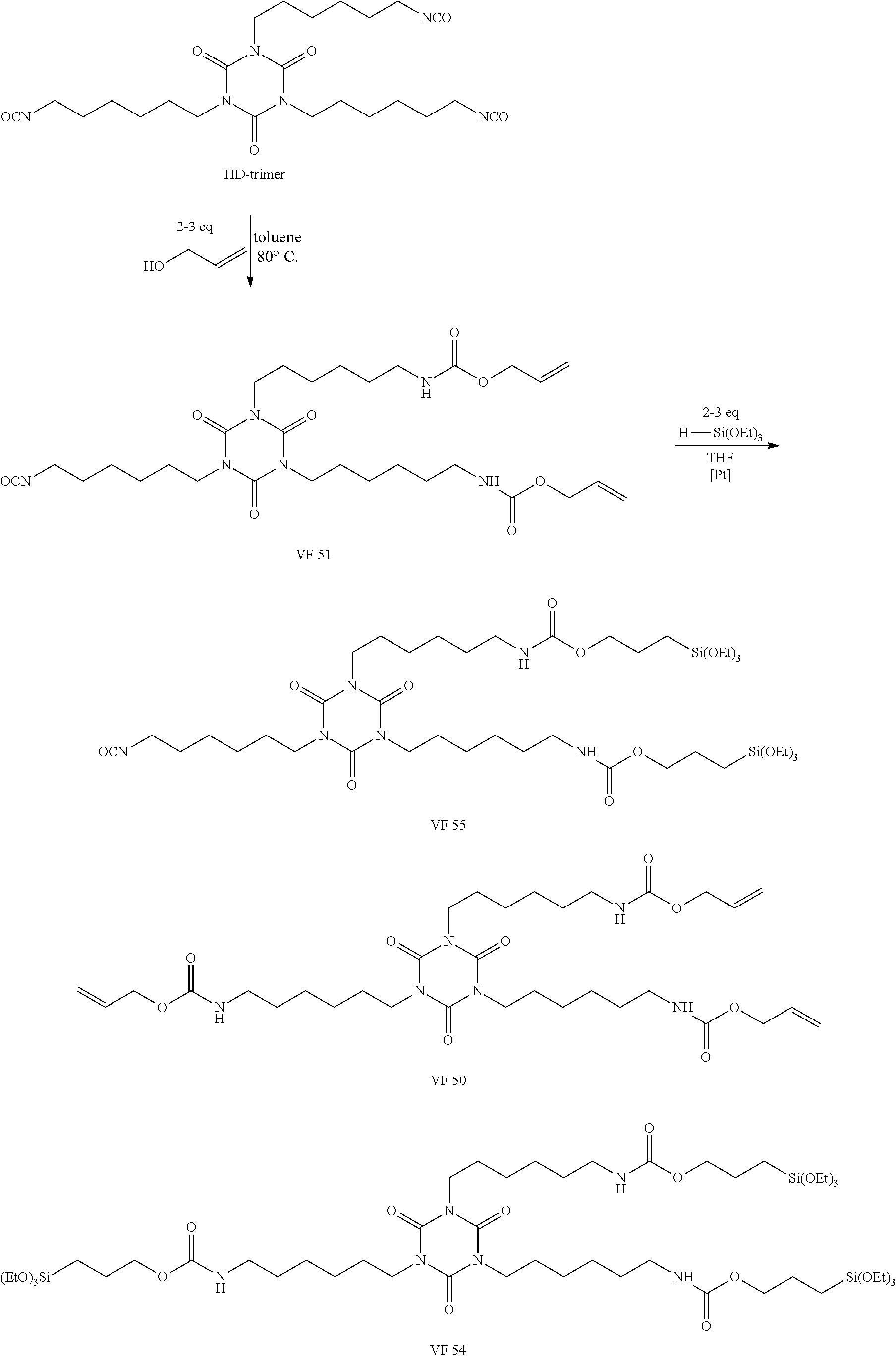

The products VF 55 and VF 54 were prepared by analogy with the procedure outlined above, using 2 equivalents of allyl alcohol and triethoxysilane for VF 51 and 55, and 3 equivalents of allyl alcohol and triethoxysilane for VF 50 and VF 54.

The products VF 55 and 54 are high-viscosity oils.

Measurements were made of the surface tension:

VF 51: ˜44 mN/m

VF 55: 30.23 mN/m

It is seen that the surface tension is lowered through attachment of the alkoxy-silanes.

The products were characterized by 1H-NMR and IR spectroscopy.

### Inventive Examples 5-6

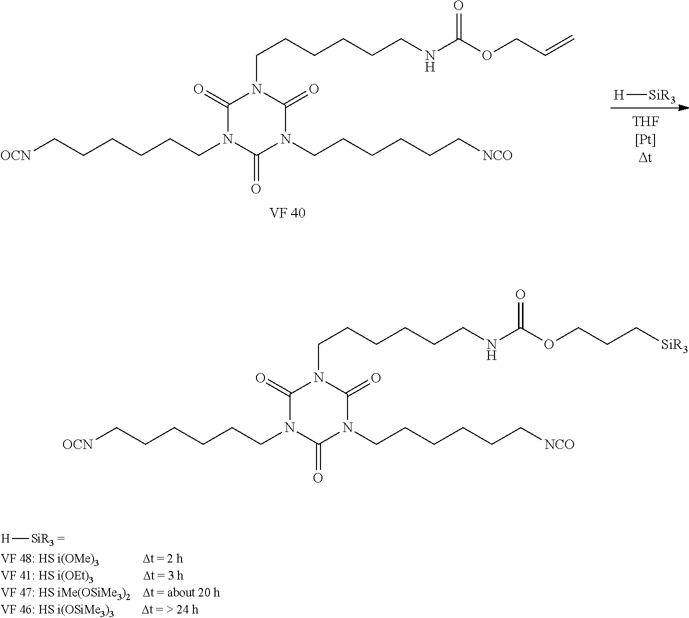

### Inventive Example 5

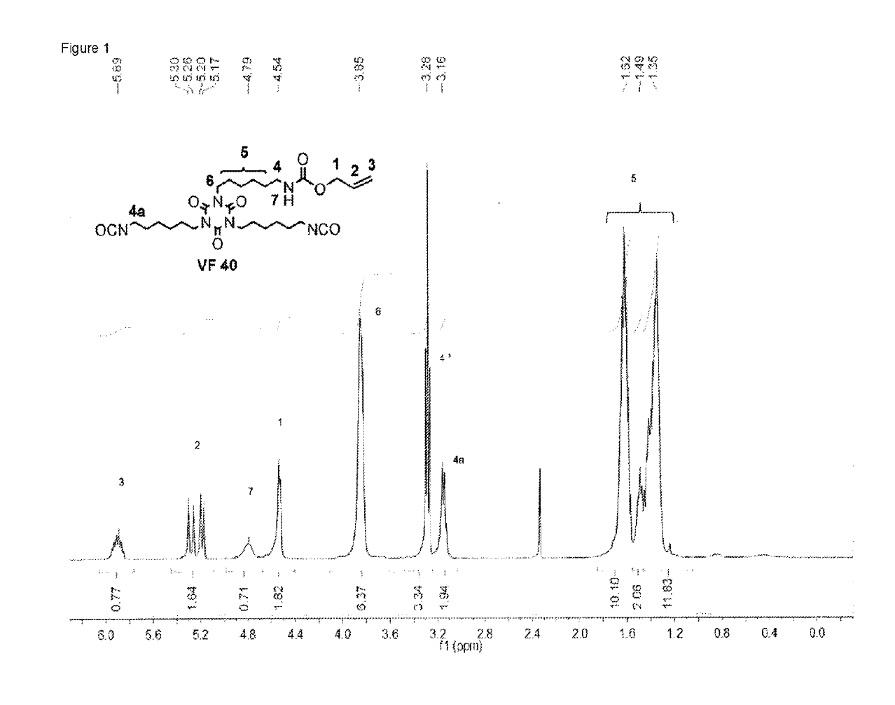

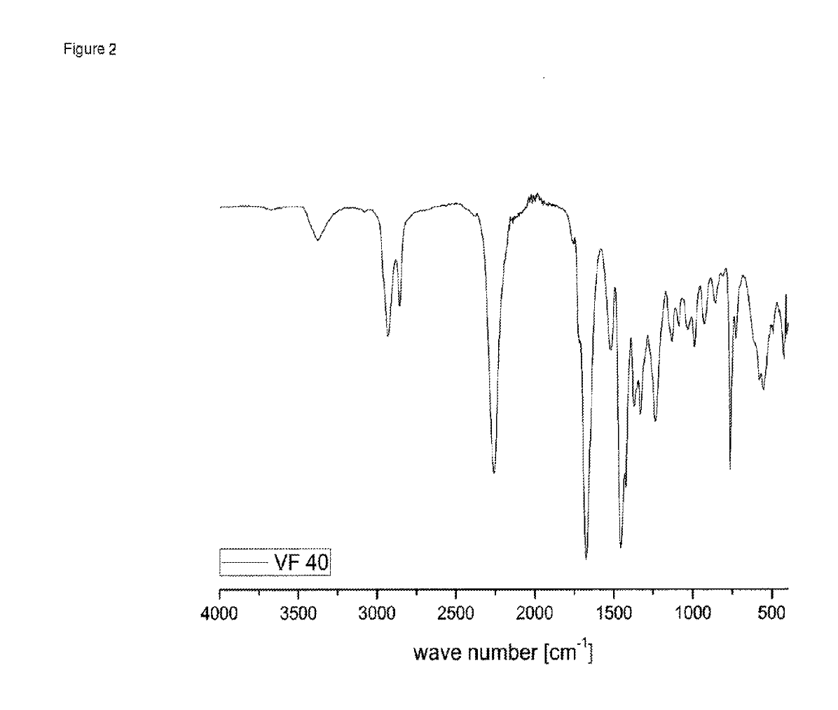

1 g of monoallylated HDI timer (VF 40; see FIG. 1 for the 1H-NMR and FIG. 2 for the IR spectrum) was dissolved in 5 ml of dry THF, 0.25 ml of trimethoxysilane from Aldrich was added, the solution was heated to 65° C., and, with vigorous stirring, 12 μl of a solution of Pt-divinyltetramethyldisiloxane (2.1% Pt) in xylene from ABCR Gelest were added. The progress of the reaction was followed using ¹H-NMR spectroscopy. After a reaction time of 2 hours, the solvents were distilled off under reduced pressure at 40° C. This gave the product VF 48 in the form of a colorless oil.

### Inventive Example 6

2 g of monoallylated HDI timer were dissolved in 5 ml of dry THF, 1.1 ml of HSiMe(OSiMe3)2 from ABCR were added, the solution was heated to 65° C., and, with vigorous stirring, 10 μl of a solution of Pt-divinyltetramethyldisiloxane (2.1% Pt) in xylene from ABCR Gelest were added. The progress of the reaction was monitored using ¹H-NMR spectroscopy. After reaction times of 2 hours and 5 hours, further portions—each 25 μl—of the catalyst solution were added. Following complete reaction, the solvents were distilled off under reduced pressure at 50° C. This gave the product VF 47 in the form of a colorless oil.

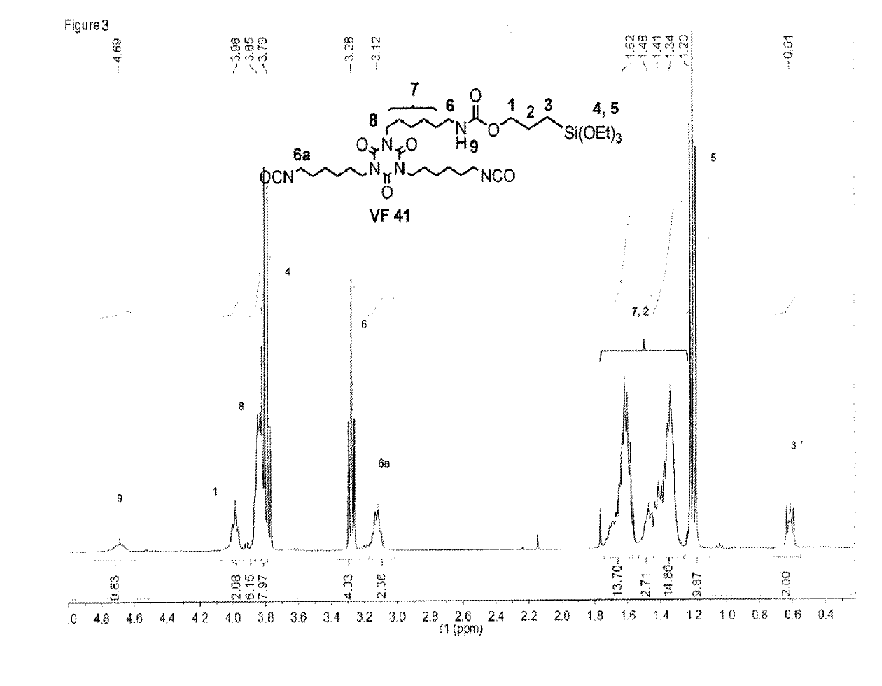

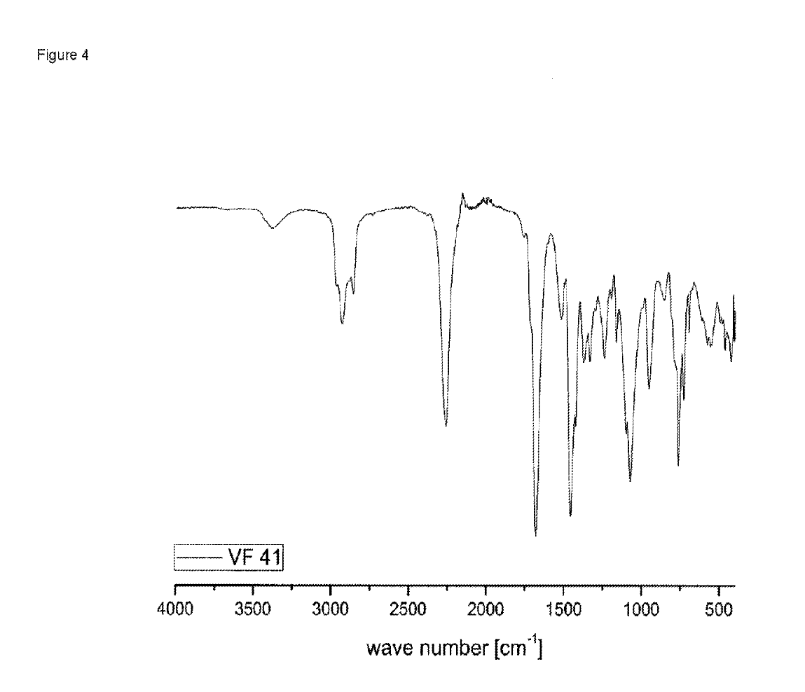

The products were characterized by 1H-NMR and IR spectroscopy: see FIG. 3 for the 1H-NMR and FIG. 4 for the IR spectrum of VF 41.

1. A process for preparing a polyisocyanate comprising a silyl group, the process comprising: reacting at least one compound (A), which is a di- or polyisocyanate with at least one compound (B), which is an unsaturated alcohol comprising a C═C double bond and a hydroxyl group to obtain a polyisocyanate comprising a urethane group, and
subsequently adding at least one compound (C), which is a silane compound comprising a Si—H bond, by a hydrosilylation, to at least some of the C═C double bonds bonded to the resultant polyisocyanate comprising the urethane group.

2. The process according to claim 1, wherein the di- or polyisocyanate comprises a aliphatic or cycloaliphatic diisocyanate or polyisocyanate which is obtained by reacting at least one aliphatic or cycloaliphatic diisocyanate.

3. The process according to claim 2, wherein the diisocyanate is selected from the group consisting of hexamethylene 1,6-diisocyanate, 1,3-bis(isocyanatomethyl)cyclohexane, isophorone diisocyanate, and 4,4′- or 2,4′-di(isocyanatocyclohexyl)methane.

4. The process according to claim 1, wherein the compound (A) is a polyisocyanate comprising an isocyanurate group, a biuret group, a urethane group, and/or an allophanate group.

5. The process according to claim 1, wherein the compound (A) is selected from the group consisting of a polyisocyanate comprising isocyanurate groups and derived from hexamethylene 1,6-diisocyanate, and a polyisocyanate comprising isocyanurate groups and derived from isophorone diisocyanate.

6. The process according claim 1, wherein the compound (C) has a formula (V) 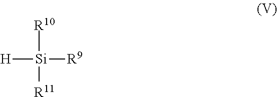
where R⁹-R¹¹ independently are
an alkyl radical or
a radical —O—R¹² ,
where
R¹² is optionally an alkyl or aryl radical.

7. A process according to claim 1, wherein the compound (C) is selected from the group consisting of triethylsilane, triisopropylsilane, dimethylphenylsilane, diethoxymethylsilane, dimethoxymethylsilane, ethoxydimethylsilane, phenoxydimethylsilane, triethoxysilane, trimethoxysilane, bistrimethylsiloxymethylsilane, and a mixture thereof.

8. The process according to claim 1, wherein the compound (B) comprises precisely one C═C double bond and precisely one hydroxyl group.

9. The process according to claim 8, wherein the C═C double bond of the compound (B) is an isolated double bond.

10. The process according to claim 1, wherein the compound (B) is selected from the group consisting of (2 propen-1-ol, 2-methyl-2-propen-1-ol, 3-buten-1-ol, 1-buten-3-ol, 3-methyl-2-buten-1-ol, 2-methyl-3-buten-2-ol, 1-octen-3-ol, 2-hexen-1-ol, 1-penten-3-ol, phytol, farnesol, and linalool.

11. The process according to claim 1, wherein a stoichiometry of the compound (B) to the isocyanate groups in the compound (A) is from 1:0.1 to 0.1:1.

12. The process according to claim 1, wherein said reacting occurs at a temperature of from 40 to 120° C. and said adding occurs at a temperature of from 40 to 80° C.

13. A silylated polyisocyanate, obtained from the process according to claim 1.

14. A coating composition, comprising:
at least one silylated polyisocyanate according to claim 13,
optionally a catalyst capable of catalyzing a reaction of isocyanate groups with isocyanate-reactive groups,
a binder comprising an isocyanate-reactive group,
optionally a coating additive,
optionally a solvent, and
optionally a pigment.

15. A method for coating a substrate, the method comprising:
coating the substrate utilizing the coating composition according to claim 14.
